(19) United States
(12) Patent Application Publication
(10) Pub. No.: US 2018/0319082 A1
(43) Pub. Date: Nov. 8, 2018

(54) ADDITIVE MANUFACTURING WITH IRRADIATION FILTER

(71) Applicant: Hewlett-Packard Development Company, L.P., Houston, TX (US)

(72) Inventors: Arthur H Barnes, Vancouver, WA (US); Pierre J. Kaiser, Portland, OR (US)

(73) Assignee: Hewlett-Packard Development Company, L.P., Houston, TX (US)

(21) Appl. No.: 15/765,074

(22) PCT Filed: Jan. 29, 2016
(86) PCT No.: PCT/US2016/015746

§ 371 Date: Mar. 30, 2018

(51) Int. Cl. B29C 64/286; B29C 64/165; B33Y 10/00; B33Y 30/00

(52) U.S. Cl. CPC B29C 64/286; B33Y 30/00; B33Y 10/00; B29C 64/165

(57) ABSTRACT

An additive manufacturing apparatus or method may include an irradiation structure, an irradiation filter to filter at least a part of the radiation, to transmit a narrower wavelength range than the received wavelength range to the media.

### BACKGROUND

Additive manufacturing techniques such as three-dimensional (3D) printing, relate to techniques for making 3D objects of almost any shape from a digital 3D model through additive processes, in which 3D objects are generated on a layer-by-layer basis under computer control. Such techniques may range from applying infrared or ultraviolet light to photopolymer powder or resin, to melting semi-crystalline thermoplastic materials in powder form, to electron-beam melting of metal powders.

An example of an additive manufacturing process begins with a digital representation of a 3D object, which is virtually sliced into layers by computer software or may be provided in virtually pre-sliced format, each layer representing a cross-section of the object. Thereby, an additive manufacturing apparatus, such as a 3D (three-dimensional) printer, builds the object layer upon layer. While some available technologies directly print material, others use a process wherein a selective object portion is solidified in order to create a cross-section of the object within a larger layer. In one example a selective portion of a powder layer is melted in order to create a solid object slice within the powder layer, so that each object slice merges with a previous slice in order to create the object within the powder.

The build material from which the object is manufactured may vary depending on the manufacturing technique and may comprise powder material, paste material, slurry material or liquid material. The object is usually built in a building area or building compartment of the additive manufacturing apparatus.

### DRAWINGS

FIG. 1 illustrates a diagram of an example of an additive manufacturing apparatus;

FIG. 2 illustrates a diagram of an example of an irradiation structure;

FIG. 3 is a graph plotting curves representing, in percentages, on a vertical axis, a relative intensity of an IR irradiation source, transmittance properties of irradiation filters, absorption properties of powder media, and absorption properties of fusing agent, and, on a horizontal axis, the corresponding wavelengths, according to examples of this disclosure;

FIG. 4 illustrates a diagram of another example of an additive manufacturing apparatus;

FIG. 5 illustrates a diagram of an example of an irradiation structure and filters;

FIG. 6 illustrates a diagram of another example of an additive manufacturing apparatus;

FIG. 7 illustrates a diagrammatic view from the bottom upwards of an example of a media manipulation structure and a printhead;

FIG. 8 is a flow chart of an example of a method of additive manufacturing;

FIG. 9 is a flow chart of another example of a method of additive manufacturing;

FIG. 10 is an example of a filter test arrangement;

FIG. 11 is an example of a diagrammatic heat distribution map of a powder layer, using the example filter test arrangement of FIG. 10; and

FIG. 12 is an example of a graph that plots temperatures of the powder layer and filter arrangement used in FIGS. 10 and 11.

### DESCRIPTION

Three-dimensional objects can be generated using additive manufacturing techniques. Each layer may be generated by solidifying portions of one or more successive layers of build material, hereafter called media. The media can be powder-based and the properties of generated objects may be dependent on the type of build material and the type of solidification. In some examples, solidification of a powder material is enabled using agents. In further examples, solidification may be enabled by temporary application of energy to the build material. In certain examples, fusing agents are applied to build material, wherein a fusing agent is a material that, when a suitable amount of energy is applied to a combination of build material and fusing agent, may cause the medial to coalesce (e.g. fuse) and solidify. In other examples, other types of media and other methods of solidification may be used. In other examples, the media includes paste material, slurry material or liquid material. An example additive manufacturing process is known as 3D printing. In this disclosure additive manufacturing or 3D printing is also referred to as “building”.

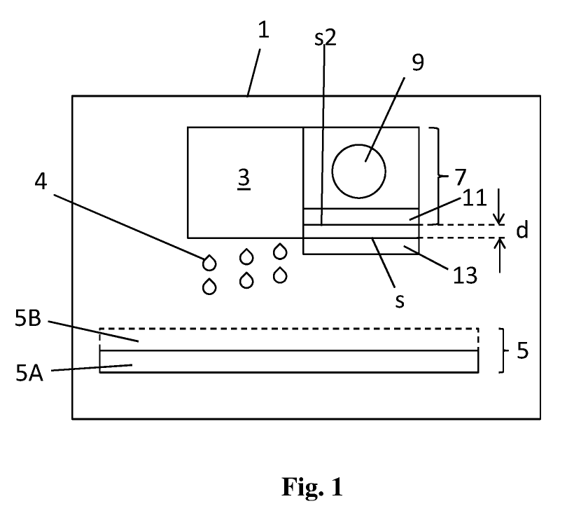

FIG. 1 illustrates a diagram of an additive manufacturing apparatus 1. The additive manufacturing apparatus 1 may be a three-dimensional (3D) printer. The apparatus 1 includes a fusing agent distributor 3 to distribute fusing agent 4 to enhance energy absorption characteristics of build media 5 that receives the fusing agent 4, at least within a certain wavelength range. The fusing agent 4 may have a higher relative energy absorption than the media 5. The fusing agent 4 may have a higher relative energy absorption over the entire wavelength spectrum or may have a higher relative energy absorption within a certain operational wavelength range. In operation, the media 5 is distributed layer 5B upon layer 5A onto a stage or media bed of the apparatus 1. The fusing agent 4 is distributed onto each layer 5A, 5B based on a digital representation of a respective slice of the to-be-built object.

The additive manufacturing apparatus 1 includes an irradiation structure 7. The irradiation structure 7 is to irradiate electro-magnetic radiation onto the media 5, for example light and/or heat in a visible and/or non-visible spectrum. The irradiation structure 7 includes an irradiation source 9 that irradiates said energy. The irradiation source 9 may be at least one of a halogen light source, filament light source, light emitting diode, laser, etc. The irradiation structure 7 further includes a cover 11. The cover 11 is at least partly transparent to allow electromagnetic radiation to pass through. The cover 11 may include glass. In one example the cover 11 is provided around and/or at a distance from a filament or other source, to (i) seal the irradiation source 9 so that gas does not escape, and/or (ii) prevent dust, powder, agent or other unintended particles from settling on the filament or other source. In a further example, the cover 11 may protect the irradiation source from outside conditions such as fingers, grease, dust, powder, liquid, ink, etc. In again a further example the cover 11 protects operators or apparatus components from the irradiation source 9 for example because the irradiation source 9 may become very hot during operation, hence reducing a risk of burning physical parts. Typically the cover 11 would be provided at a small distance from the irradiation source 9 to avoid large sizes. In practice the covers heat up, for example to temperatures of approximately 250 to 350 degrees Celsius. Many example off-the-shelf irradiation sources 9 are standardly provided with a glass or otherwise protective cover 11.

The additive manufacturing apparatus 1 further includes a radiation filter 13 to filter a certain wavelength range of electro-magnetic radiation. The filter 13 allows wavelengths within a narrower wavelength range than the originally irradiated wavelengths to pass through the filter 13 to the media 5. In one example, the filter 13 is a short-pass filter to filter energy below a certain wavelength. In another example, the filter 13 is a long-pass filter to filter energy above a certain wavelength. In a further example, the filter 13 may be a combination of a long pass and short pass filter, for example to transmit within a relatively narrow wavelength range. In different examples, the filter 13 may encompass different filter assemblies or combinations of filters.

The irradiation filter 13 is arranged at a distance d from the cover 11. For example the distance d may be approximately 1 to 60 millimeters or approximately 5 to 40 millimeters, from the top surface s of the filter 13 to the nearest surface s2 of the cover 11. In a further example the distance d is between approximately 10 and 35 millimeter, for example 25 millimeter.

In different examples, the filter 13 may be a reflective or absorptive filter 13. If the filter 13 is reflective, it reflects non-transmitted parts of the radiation. A reflective filter can be made of a mirror with a filter coating on it. For example, a reflective filter can be a hot or cold mirror, for short or long pass filter, respectively. If the filter 13 is absorptive, it absorbs the non-transmitted energy so that its temperature increases. An absorptive filter can be made of absorptive material without necessarily having a coating. For both reflective and absorptive filters 13, heat can be irradiated from the filter 13, which in turn may further heat particular parts of the irradiation structure 7. A safe distance d between the filter 13 and the cover 11 may help prevent the temperature of the cover 11 from exceeding a certain operational temperature range. For example, the filter 13 can be positioned at a distance d from the cover 11 so as to maintain the temperature of the cover below approximately 400 degrees Celsius, or below approximately 350 degrees Celsius. In turn, a safe temperature of the cover 11 can help prevent negatively affecting operating conditions of the irradiation source 9 such as temperature, power consumption, and current, amongst others.

In other examples, the distance d may prevent that the filter 13 itself heats up too much by absorbing a relatively high amount of energy on a relatively small surface. The distance d may also facilitate actively cooling the filter 13, for example with a cooling mechanism connected to the filter 13. By setting the appropriate distance d, with or without an active cooling mechanism, too much heating of the filter 13 may be inhibited, whereby the filter's temperature is maintained, which in turn may allow for a wider variety of suitable filters 13. In yet other examples, the distance d between the filter 13 and the cover 11 may have different advantages then mentioned above such as facilitating relatively easy and safe replacement of the filter 13.

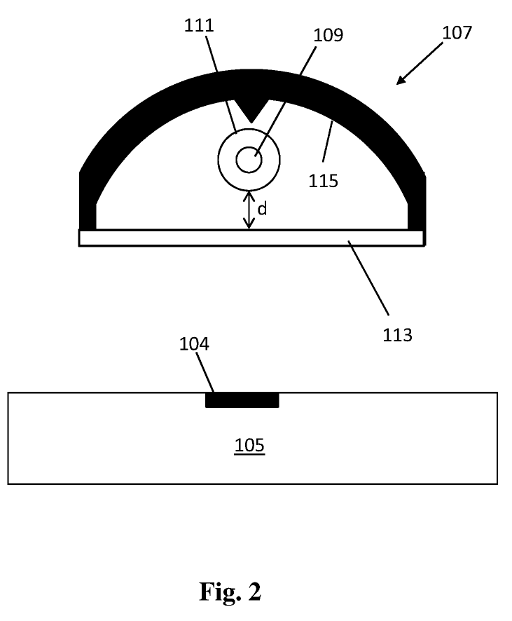

FIG. 2 illustrates an example of an irradiation structure 107 with a filter 113. The irradiation structure 107 includes an irradiation source 109 that is provided within a transparent cover 111. In one example the irradiation source 109 is an IR (infra-red) lamp including at least one tungsten filament that is provided within halogen gas. The cover 111 is a quartz glass seal that contains the halogen gas. The cover 111 may be generally tube-shaped. The irradiation structure 107 further includes a reflector 115 to reflect irradiation from the source 9 towards the media 105. The reflector 115 may be a generally shell-shaped mirror on the opposite side of the source 9 with respect to the media bed.

The irradiation source 109 may be arranged to irradiate infrared light. For example, the irradiation source 109 may be optimized to irradiate in the near-IR and short-IR wavelength range, for example from 0.5 to 2 microns, approximately. The irradiation may include further larger and shorter wavelengths of lower intensities. In one example, the quartz tube may filter wavelengths above 3.5 or above 4 micron. For example the quartz tube may have an outer diameter of approximately 12 millimeters or less, 10 millimeters or less, for example 8 millimeter, with a spiraled filament inside in the middle. The filament may have a 3-4 millimeters distance from the glass' inner surface. In further examples, the irradiation structure may include a heat source of a similar type IR lamp that is adapted to heat non-fused powder, wherein the quartz tube may have a larger diameter, for example approximately 14 millimeters.

In the illustrated example, the irradiation filter 113 is provided at a distance from the cover 111. The irradiation filter 111 may be mounted to the irradiation structure 107, for example to the lamp reflector 115 or to a frame that holds the reflector 115. In one example, a short pass filter 113 may transmit wavelengths below approximately 2.2 microns, or for example below approximately 2 microns, while blocking higher wavelengths. Most or all energy of lower wavelengths will reach the media 105 while higher wavelengths will be absorbed or reflected. In other examples, long pass filters may be used, as will be further explained below.

In one example that is illustrated in FIG. 2, part of the media 105 has fusing agent 104 dispensed thereon. The patch of the media 105 with fusing agent 104 may have a high relative absorption rate in the wavelength range below approximately 2.2 micron or below approximately 2 micron while the surrounding media 105, that has not fusing agent on it, may be substantially transparent to these wavelengths, or at least sufficiently non-absorbing to prevent fusing. By blocking the wavelengths above 2, 2 or above 2 micron, unintentional absorption of the higher wavelengths by the surrounding media 105 may be inhibited while the effective wavelengths are allowed to pass through. In one example unintentional partial fusing or “caking” of powdered media without any agent, for example near the borders of an object, is inhibited while intentional fusing of powder with agent is not affected.

The distance d of the filter 113 to the cover 111 can be between approximately 5 and 60 millimeter, for example between 10 and 40 millimeter, for example approximately 25 millimeter. The distance between the filter 113 and the filament may for example be between approximately 6 and 70 millimeters, for example between 12 and 44 millimeters, for example between approximately 25 and 31 millimeters. This may help prevent heat being dissipated by the filter 113, which could negatively affect the irradiation structure 107. However, the heat dissipation of the filter may also be influenced by other aspects than distance d from the cover, such as for example a thickness of the filter 113. In one example, the filter 113 may have a thickness of approximately 0.5 to 7 millimeters. One example, a reflective filter or reflective coating has a thickness in the 0.5 to 2 millimeters range. In certain examples suitable material for a reflective mirror may include at least one of fused quartz, borosilicate, crystal quartz, calcite, rutile, sapphire, magnesium fluoride, sodium chloride. In one example, an absorptive filter has a thickness in the 1 to 7 millimeters range, for example 2 to 5 millimeters. In certain examples, suitable material for an absorptive filter may include borosilicate or germanium.

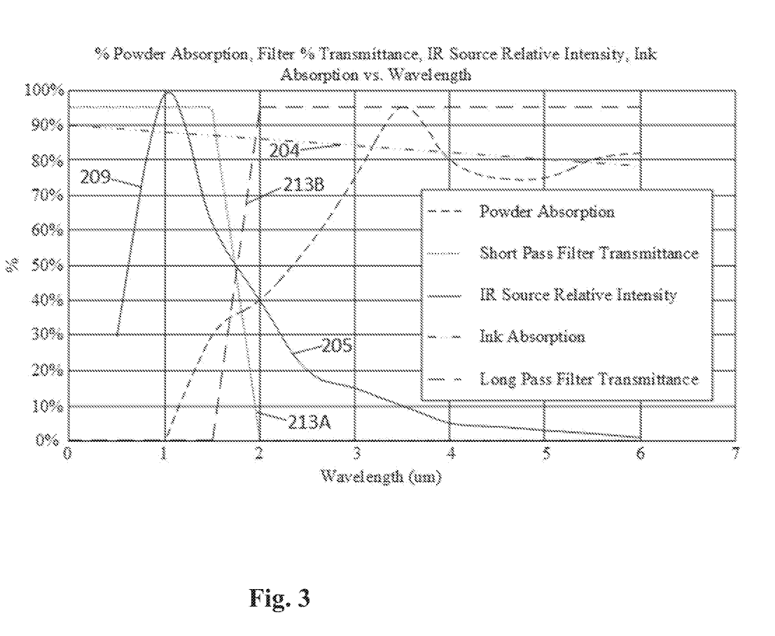

FIG. 3 illustrates a graph of certain properties of an example additive manufacturing apparatus of this disclosure. The curves represent example properties of an IR irradiation source, two different irradiation filters, powder media, and fusing agent. The graph plots, on a vertical axis, relative intensity, filter transmittance, powder absorption, and fusing agent absorption, respectively, in percentages, and, on a horizontal axis, the corresponding wavelengths. A first curve 209 represents a relative intensity of an IR source for each wavelength. As illustrated by the first curve 209, the relative intensity of the IR source has its peak around 1 micron, while the relative intensity is above approximately 50% somewhere between approximately 0.6 and approximately 1.9 micron.

A second curve 213A illustrates transmission properties of a short pass irradiation filter. As illustrated by the second curve 213A, the short pass filter allows wavelengths of below approximately 2 microns to transmit to the media. As also illustrated, the filter starts reducing the relative intensity of the transmitted IR light around 1.5 microns. The short pass filter may inhibit too much heating of not-to-be fused powder while allowing the powder with agent to fuse normally. A third curve 2138 represents a different, long pass filter 2138. As illustrated by the third curve 2138, the long pass filter allows wavelengths longer than approximately 1.5 microns to transmit to the media. As also illustrated, the filter starts reducing the relative intensity of the transmitted IR light around 2 microns. A long pass filter 2138 could be used to allow an entire powder layer to heat efficiently while reducing a risk of reheating or overheating a (partly) fused portion with agent. This may prevent thermal bleed of the fused portion which could cause the object slice to grow. In one example, the additive manufacturing apparatus could include multiple irradiation sources, wherein at least one assembly of an irradiation source with a short pass filter could be adapted to fuse and another assembly of an irradiation source with a long pass filter could be adapted for heating. In one example, the filter is at least one of (1) a short pass filter to at least partly block wavelengths above approximately 2.2 microns, or above approximately 2 microns; and (ii) a long pass filter to at least partly block wavelengths below approximately 1.3 microns, or below approximately 1.5 microns.

A fourth curve 205 illustrates a relative energy absorption of powder. As illustrated by the fourth curve 205, the powder media starts to absorb energy at relatively low intensities at around approximately 1 micron while the absorption peak may be around approximately 3.5 microns. A fifth curve 204 illustrates a relative energy absorption of a fusing agent. As illustrated by the fifth curve 204, the absorptive properties of the fusing agent are higher where the wavelengths are shorter. However the relative absorption remains relatively high over the entire illustrated spectrum. In one example, the filter is to allow wavelengths that have relatively high source intensity and relatively high fusing agent absorption properties to pass through, such as a range below 2 microns, while it absorbs and/or reflects the effective absorption wavelengths of powder without agent, as per curve 205, for example wavelengths above 2 microns.

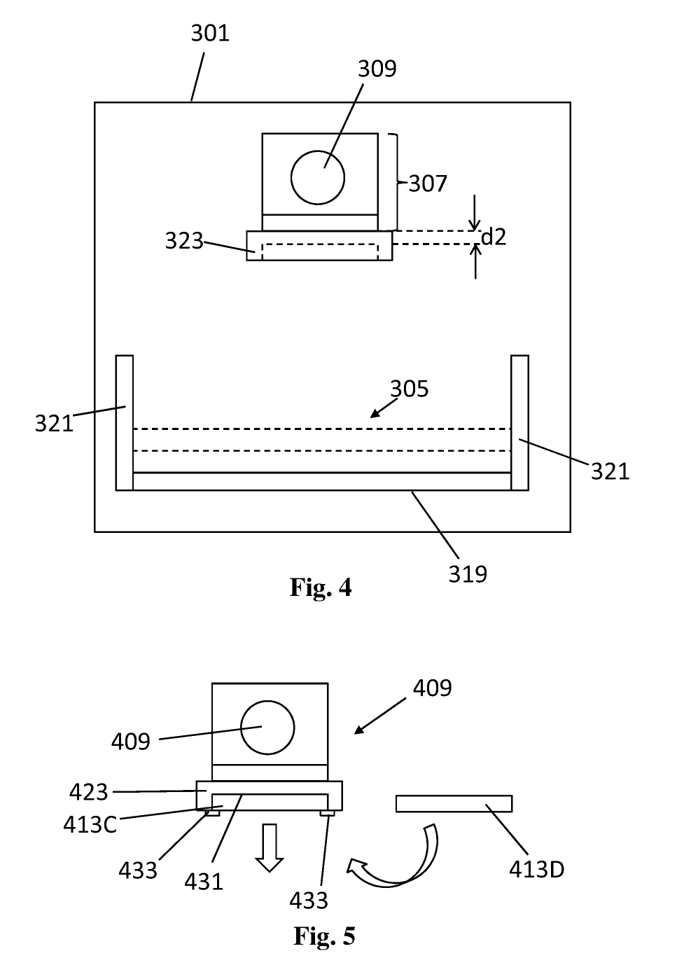

FIG. 4 illustrates another example of an additive manufacturing apparatus 301. The additive manufacturing apparatus 301 includes a media stage 319. The stage 319 is to support layers of media 305. Walls 321 surround the stage 319 to retain the media 305. The stage 319 may be connected to a transmission and a drive to vertically move the stage 319 with respect to a powder dispensing mechanism, to facilitate distribution of the layers onto the stage 319.

The additive manufacturing apparatus 301 includes an irradiation structure 307. The irradiation structure 307 includes an irradiation source 309 and a filter holder 323 to hold a filter 313 between the source 309 and the stage 319 at a distance d2 from the source 309, to filter at least a part of the radiation, to transmit wavelengths of a narrower wavelength range than the originally emitted wavelength range by the source 309. In one example, the irradiation structure 307 includes a cover to protect or seal the irradiation source, wherein the filter holder is to hold the filter at a distance from the cover.

The filter holder 323 is adapted to allow the filter to be readily coupled and decoupled with respect to the irradiation structure 307. For example, the filter holder 323 includes at least one of a holder rail, screws, click fingers, glass holder plates, etc. that hold the filter in place while allowing it to be readily coupled and decoupled with respect to the irradiation structure 307. For example, the filter can be replaced because of filter wear, or because different wavelength characteristics are desired, or because of replacing the irradiation source 309 or for other reasons.

FIG. 5 illustrates an irradiation structure 407 of this disclosure with different filters 413C, 413D. The filter holder 423 has a filter receiving surface or rail 431 to position the filters 413C, 413D, and at least one retainer 433 to hold the filters 413C, 413D in place. The retainer 433 may include at least one of screw thread, a click finger, a latch, etc. The filter holder 423 may allow for the filter 413C to be taken off so as to irradiate powder without filter, or for replacing the filter 413C. In the example illustration, the filter holder 423 holds a first irradiation filter 413C having first characteristics. The first filter 413C can be replaced by a second irradiation filter 413D having second characteristics that are different than the first characteristics. The different characteristics may be at least one of (i) different wavelength transmissivity versus blocking characteristics, (ii) different heat exchange characteristics, and (iii) different absorptive or reflective characteristics. The first and the second filter 413C, 413D may have approximately the same dimensions. In one example, the first filter 413C is a short pass filter and the second filter 413D is a long pass filter. Reasons for switching filter may include a different powder characteristics, different print speeds, different desired fusion characteristics, different fusing agent colors (wherein the agent may be an ink), different size filters, different desired heat characteristics, etc.

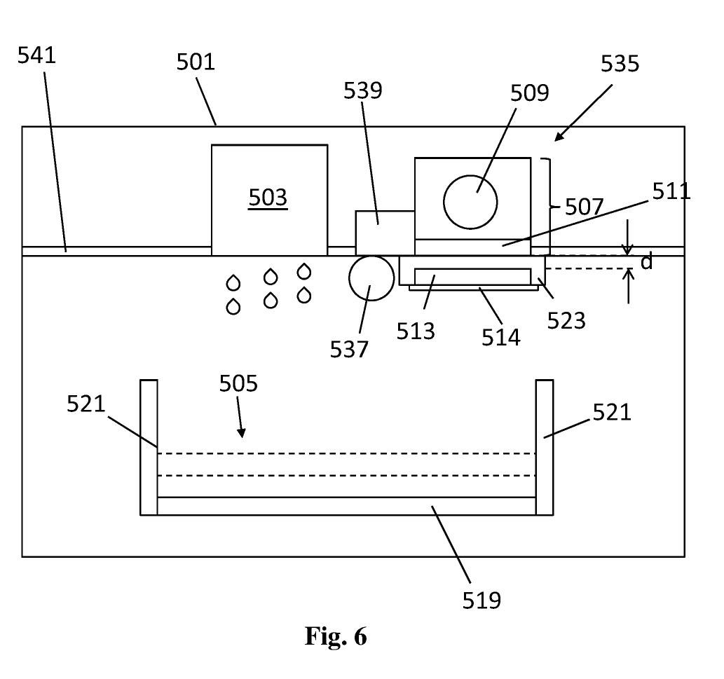

FIG. 6 illustrates another example of an additive manufacturing apparatus 501. The additive manufacturing apparatus 501 is provided with a movable media stage 519 and walls 521, for supporting media 505 during additive manufacturing. The additive manufacturing apparatus 501 further includes a media manipulating structure 535. The media manipulating structure 535 includes an irradiation structure 507 and a media distributor 537. The media distributor 537 may be connected to a media supply 539 that supplies the media to the stage 519, either directly to the stage 519 or through the media distributor 537. In one example the media distributor 537 is a roller or shovel to distribute powder media over the stage 519 so as to provide a relatively even top surface.

The additive manufacturing apparatus 501 also includes an agent distributor 503. In one example the agent distributor 503 includes a fusing agent distributor and a detailing or inhibitor agent distributor. The additive manufacturing apparatus 501 includes at least one rail 541 over which the agent distributor 503 and the media manipulating structure 535 scan. For example each of the agent distributor 503 and media manipulating structure 535 may be provided on the same carriage or on different carriages that scan over the rail 541. The agent distributor 503 may be adapted to be able to distribute agent over a width of the stage 519, so that the entire stage can be covered in one scanning movement. Similarly, the media distributor 537 and the irradiation structure 507 may be adapted to distribute media and to irradiate media, respectively, over an entire width of the stage 519, so that the entire stage can be covered in one scanning movement. As illustrated, the irradiation filter 513 is mounted to the media manipulation structure 535 so as to cover the irradiation structure 507, at a distance d from a cover 511 of the irradiation structure 507. In this example, the additive manufacturing apparatus 501 includes a filter cooling mechanism 514. The cooling mechanism 514 extends at least partly provided along the filter 513, to cool the filter 513. In one example the filter cooling mechanism may be connected to or integral to the filter holder 523. In one example, the filter cooling mechanism 514 may be part of a larger cool circuit of the additive manufacturing apparatus 501. In another example, the cooling mechanism 514 may include an air moving device such as a ventilator. In yet another example, the filter cooling mechanism 514 may be a heat exchange arrangement such as heat fins.

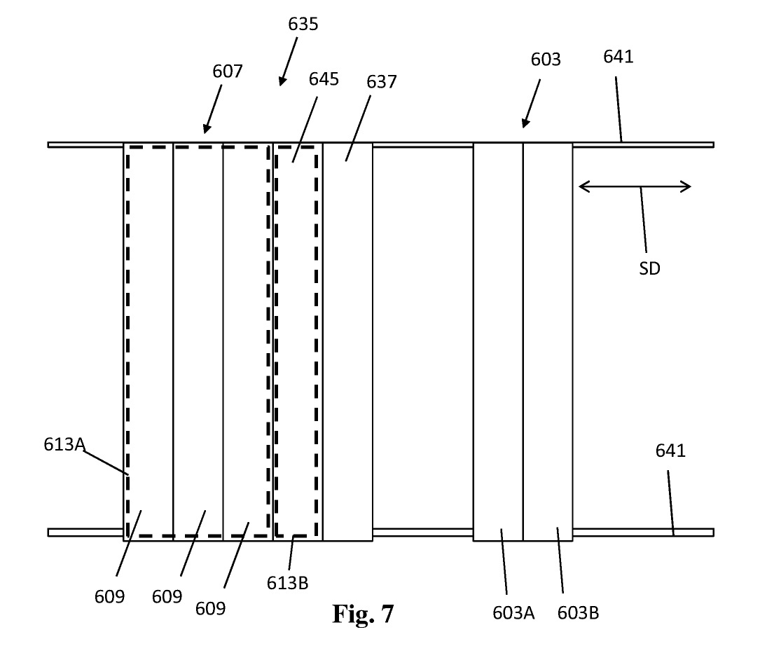

FIG. 7 illustrates a view from the bottom up to a media manipulating structure 635 and agent distributor 603 mounted on rails 641. The media manipulating structure 635 and agent distributor 603 are to scan over the rail 641, to manipulate media layers, along a scanning direction SD.

In the illustrated example, the agent distributor 603 includes two media wide agent printheads 603A, 603B, wherein the media width is perpendicular to the scanning direction SD. In this disclosure a printhead may refer to a printhead assembly, for example including at least one array of multiple printhead dies. In one example, one printhead may be to dispense ink of one color, for example black, and another printhead may be to dispense ink of another color for example non-black. In another example one printhead assembly may be to dispense fusing agent and another printhead may be dispense detailing agent. In yet another example each printhead may be to dispense at least two different types of ink and/or agent.

The media manipulating structure 635 includes a media wide media distributor 637 to distribute media over a stage. The media manipulating structure 635 may further include a heat source 645 to heat the media, for example to pre- or post-heat the media. In an example, the heat source 645 may include an IR heat source. The media manipulating structure 635 may further include at least one IR light source 609 to irradiate the media over its width. Glass covers may protect each of the light sources 609. In the illustrated example three parallel IR light sources 609 are provided. In one example, a short pass irradiation filter 613A is mounted to the irradiation structure 607 so as to cover the IR irradiation sources 609 but not the heat source 645. In another example, a long pass irradiation structure 613B is mounted to the irradiation structure 607 to cover the heat source 645 but not the irradiation sources 609. The heat source 645 and irradiation sources 609 may be IR quartz-halogen lamps of different respective characteristics.

The heat source 645 may be similar to the IR irradiation sources 645. For example, the filter can be moved over or slid into the rails 641 so that different parts of the irradiation structure can be covered by the filter 613. For example the position and type of the filter 613 can be chosen to optimize the irradiation conditions of the media depending on the type of powder, agent, ink color, etc.

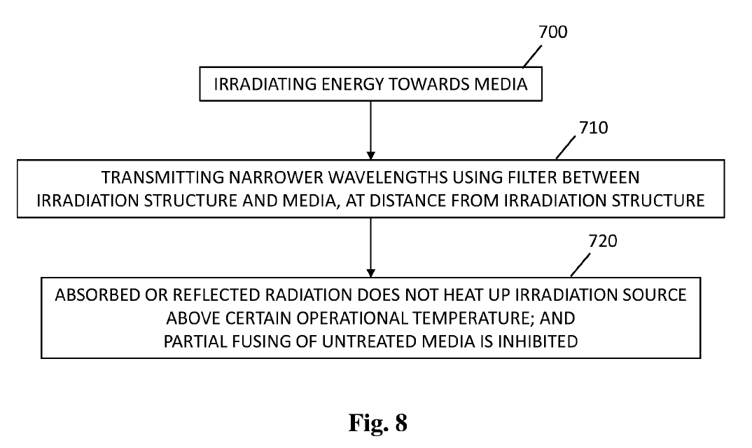

FIG. 8 illustrates a flow chart of an example of a method of additive manufacturing. The method includes irradiating energy towards additive manufacturing media (block 700). The method further includes transmitting a narrower wavelength range than the originally irradiated wavelengths using a filter positioned between an irradiation structure and the media at an appropriate distance from the irradiation source and/or a cover (block 710). The distance facilitates that the heat generated by the radiation that is absorbed or reflected by the filter is prevented from increasing the temperature of the irradiation structure beyond an operational temperature range, while partial or complete fusing of media without fusing agent dispensed thereon is inhibited (block 720). In one example, the distance between the filter and the irradiation structure may be 10 millimeters or more, as measured from a cover of the irradiation structure. In one example, a glass cover of the irradiation structure maintains a temperature lower than approximately 400 degrees Celsius or lower than approximately 350 degrees Celsius. In another example, the irradiation source itself is prevented from increasing beyond an operational temperature range by choosing an appropriate distance between the filter and the cover.

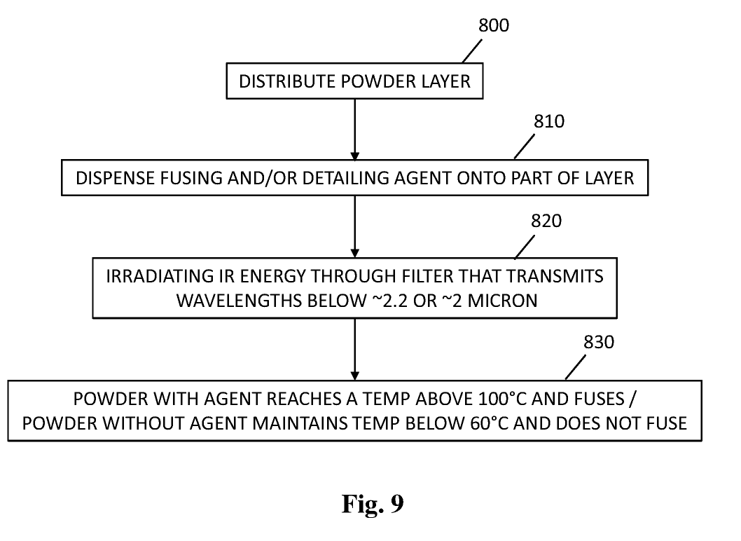

FIG. 9 illustrates a flowchart of an example of a method of additive manufacturing. The method includes distributing a powder layer (block 800), on a powder bed on a stage or directly on the stage if it is a first layer. The method further includes dispensing an agent, such as fusing and/or detailing agent, onto the powder layer (block 810). In certain examples the fusing agent includes ink such as black ink. The method further includes irradiating the powder layer with said IR radiation through an irradiation filter that transmits wavelengths below approximately 2.2 micron, or below approximately 2 micron (block 820). In an example, the filter extends over the width of the powder bed and covers the IR irradiation source, but not the heat source. The method further includes that to-be-fused portions of the powder layer (i.e. powder with fusing agent dispensed thereon) reach a temperature above 100 degrees Celsius, on average during irradiation, while not-to-be-fused portions of the powder layer (i.e. powder with no fusing agent) reach a temperature below 60 degrees Celsius, on average during irradiation (block 830). The not-to-be-fused portions of the powder layer may contain detailing agent, for example near borders of the to-be-fused portions.

In one example, the method provides that not-to-be-fused portions of the powder layer are maintained at an acceptably low point. If the temperature of not-to-be-fused portions of the powder would be too high, there could be a risk of powder partly fusing or “caking” undesirably, for example, near borders of the object. As a consequence of the filter, to-be-fused powder portions will fuse while fusing is inhibited for the not-to-be-fused portions. The fusing of powder without fusing agent is inhibited by the short pass filter and/or by a combination of the short pass filter and detailing agent. Hence, the filter may facilitate building objects at a relatively high level of detail and/or with relatively smooth object surface characteristics.

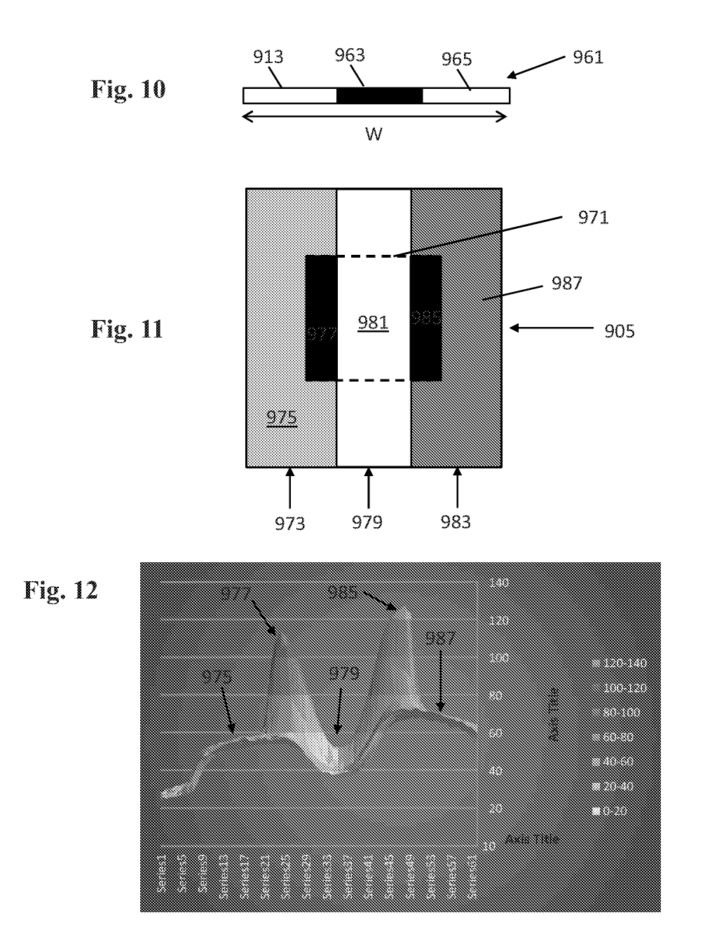

FIG. 10 illustrates a diagram of a side view of a filter test arrangement 961. The viewing direction is a scanning direction. The filter test arrangement 961 is placed in place of the above disclosed irradiation filter in an additive manufacturing apparatus for testing purposes. In operation the filter test arrangement is positioned below IR radiation sources. The IR irradiation sources extend over the width W of the filter test arrangement to scan over a powder bed in the scanning direction. The filter test arrangement 961 has an irradiation filter 913 that transmits wavelengths below 2 micron, in the illustration on the left. The filter test arrangement has a blocking portion 963 in the middle that does not transmit any radiation. The filter test arrangement has a non-filtering portion 965 that transmits all radiation, in the illustration on the right.

FIG. 11 illustrates an example of a resulting powder layer heat distribution diagram during or shortly after irradiation of the irradiation structure through said filter test arrangement. Before irradiation, a patch 971 of fusing agent was dispensed on the powder bed 905. Filtered energy, transmitted by the irradiation filter 913, has reached a left side 973 of the powder bed. Said left side 973 of the powder bed includes a filtered and fused powder layer portion 977 that has reached a temperature of at least 100 degrees Celsius on average, and a filtered and unfused powder layer portion 975 that has reached a temperature below 60 degrees Celsius on average. Irradiation was blocked by the blocking portion 963 for a middle stroke 979 of the powder bed. During (or shortly after) radiation, a temperature of the middle stroke may be below 60 degrees Celsius or below approximately 55 degrees Celsius, on average, wherein such temperature may be influenced by neighboring fused and unfused powder, diffused radiation, 3D build cabin temperature, etc. Also, part of the middle stroke 981 contains the fusing agent which may locally increase the media temperature. Unfiltered energy has reached a right side 983 of the powder bed. The right side 983 of the powder bed includes an unfiltered and fused powder layer portion 985 that has reached a temperature of at least 120 degrees Celsius on average, and an unfiltered and unfused powder layer portion 987 that has reached a temperature or around 70 degrees Celsius and below.

The heat distribution diagram of FIG. 11 is also represented in the graph of FIG. 12. The graph of FIG. 12 plots temperature in degrees Celsius on a vertical axis against a location along the width of the powder bed on a horizontal axis. The lower left portion of the graph corresponds with the left filtered and unfused powder 975. The left peak 977 corresponds with a temperature of the left filtered and fused powder layer portion 977. The lower middle portion corresponds with the middle stroke 979. The right peak corresponds with a temperature of the right unfiltered and fused powder layer portion 985. The lower right portion of the graph corresponds with a temperature of the right unfiltered and unfused powder 987. Hence, FIGS. 10-12 illustrate that a 2 microns short pass filter (left side 913, 973) provides for an acceptably low temperature in the unfused powder portion and an acceptably high temperature in the fused powder portion.

While this disclosure refers mostly to “an object”, in fact, multiple objects or object parts may be manufactured in a single build job in the context of this disclosure. In fact, an object may be interpreted as a plurality of objects that are physically detached from each other. While this disclosure refers mostly to a memory of the build module, the build module may include multiple memories, for example extra memories that have back-up functions.

What is claimed:

1. An additive manufacturing apparatus, comprising
a fusing agent dispenser to dispense fusing agent onto media,
an irradiation structure, including an irradiation source to radiate energy onto the media and an at least partly transparent cover,
an irradiation filter at a distance from the cover to block at least a part of the radiation, to transmit a narrower wavelength range than the received wavelength range to the media.

2. The additive manufacturing apparatus of claim 1 wherein the distance between the filter and the cover is such that in operational conditions the temperature of the cover is kept below approximately 400 degrees Celsius.

3. The additive manufacturing apparatus of claim 1 wherein the irradiation source is an infrared light source and the filter is at least one of
a short pass filter to at least partly block wavelengths above approximately 2.2 micron, and
a long pass filter to at least partly block wavelengths below approximately 1.3 micron.

4. The additive manufacturing apparatus of claim 1 wherein the irradiation source has a peak intensity in the 0.5-2 micron wavelength range.

5. The additive manufacturing apparatus of claim 1 wherein the cover comprises glass.

6. The additive manufacturing apparatus of claim 1 wherein the filter is at least one of
an absorptive filter, and
a reflective filter.

7. The additive manufacturing apparatus of claim 1 comprising a filter cooling mechanism that cools the filter.

8. The additive manufacturing apparatus of claim 1 comprising a filter holder to couple and decouple the filter.

9. A set of:
the apparatus of claim 8, wherein said filter is a first replaceable filter, and
another replaceable filter that has different characteristics than the first replaceable filter, the different characteristics comprising at least one of
blocking different wavelengths ranges;
different heat exchange characteristics; and
different absorptive or reflective characteristics.

10. The additive manufacturing apparatus of claim 1 wherein
the irradiation structure further comprises a heat source, and
the filter is positioned to cover the infrared light source but not the heat source.

11. The additive manufacturing apparatus of claim 1, comprising
a media stage to support the media during additive manufacturing,
a media manipulating structure above the stage, wherein
the media manipulating structure comprises the irradiation structure with said filter and a media distributor, and
the filter extends over a width of the stage.

12. The additive manufacturing apparatus of claim 1 wherein the media is powder and the fusing agent is ink.

13. An additive manufacturing method comprising:
irradiating energy towards additive manufacturing media,
transmitting a narrower wavelength range than the originally irradiated energy using a filter positioned between an irradiation structure and the media at a distance from the irradiation source so that
heat generated by the radiation that is absorbed or reflected by the filter is prevented from increasing the temperature of the irradiation structure beyond an operational temperature range, and
partial or complete fusing of not-to-be-fused media is inhibited.

14. The additive manufacturing method of claim 13 wherein
the media is powder, and
the irradiated energy includes heat and infrared radiation, further comprising
distributing a layer of powder,
dispensing fusing agent onto a powder layer, and
irradiating the powder layer through a filter that filters the infrared radiation so that the transmitted radiation has wavelengths below approximately 2.2 micron, wherein the to-be-fused portion of the powder layer reaches a temperature above 100 degrees Celsius, on average during irradiation, and the not-to-be-fused portion of the powder layer reaches a temperature below 60 degrees Celsius, on average during irradiation.

15. An additive manufacturing apparatus, comprising
a media stage for supporting additive manufacturing media,
an irradiation structure, including an irradiation source to radiate energy towards the stage,
an irradiation filter holding structure to hold a filter between the irradiation structure and the stage at a distance from the irradiation structure, to filter at least a part of the radiation, to allow wavelengths of a narrower wavelength range than the originally emitted wavelength range to pass through towards the stage.
